(19) United States
(12) Patent Application Publication
(10) Pub. No.: US 2026/0310863 A1
(43) Pub. Date: Oct. 8, 2026

(54) SYSTEM AND METHOD FOR DESIGNING DIGITAL PREFORM USING CNN ACCORDING TO DESIGN CONDITIONS FOR 3D SHAPE FORGING

(71) Applicant: Sogang University Research & Business Development Foundation, Seoul (KR)

(72) Inventors: Naksoo KIM, Seoul (KR); Joonhee PARK, Seoul (KR); Donghwi PARK, Seoul (KR)

(73) Assignee: Sogang University Research & Business Development Foundation, Seoul (KR)

(21) Appl. No.: 19/654,776

(22) Filed: Apr. 22, 2026

(30) Foreign Application Priority Data
Apr. 22, 2025 (KR) 10-2025-0052467

(51) Int. Cl. G06F 30/27; G06F 30/23

(52) U.S. Cl. CPC G06F 30/27; G06F 30/23

(57) ABSTRACT

Disclosed are a system and method for designing a digital preform using a CNN according to design conditions for a 3D shape forging, which satisfy design requirements for a forging by using a 3D U-Net, that is, a type of CNN. By providing a method of designing a 3D preform during a forging process by applying a CNN algorithm using a finite element model (FEM) analysis simulation, it is possible to remove underfill and folding defects of a forging, to minimize a flash and a load, and design a preform that satisfies design requirements, such as the degree of crystal grain of a target and a flow line, by using the same method as a method of removing a folding defect.

### CROSS-REFERENCE TO RELATED APPLICATIONS

This application claims priority to Korean Patent Application No. 10-2025-0052467, filed Apr. 22, 2025, the entire disclosure of which is incorporated herein by reference.

### BACKGROUND

### 1. Technical Field

The present disclosure relates to a digital preform design system, and particularly, to a system and method for designing a digital preform using a convolutional neural network (CNN) according to design conditions for a three-dimensional (3D) shape forging, which satisfy design requirements for a forging by using 3D U-Net, that is, a type of CNN.

### 2. Related Art

In the existing preform design method, research has been basically carried out on an axisymmetric shape.

In this case, a method of predicting and designing a preform by simplifying an axisymmetric forging in a two-dimensional (2D) manner has been applied, but an actual forging process is performed in a three-dimensional (3D) manner. According to 2D analysis, it may be said to be difficult in properly reflecting various defects and deformation distributions appearing during an actual forging process because deformation behaviors at all locations are assumed to be the same on the basis of an axis. Accordingly, such a method cannot be applied to forgings having non-axisymmetric shapes.

A preform design method in which a 3D shape is considered is present, but has been designed for the purpose of a simple reduction of a forging load and a flash in which a limit and design requirements called a ½ plane symmetry shape are not considered. Furthermore, in the existing 2D and 3D preform designs, initial learning data is generated based on a geometric form of a final shape, and a systematic method capable of gradually improving a learning effect has not been constructed.

The present disclosure is intended to propose an optimal preform design method, which overcomes and supplements all of such previous limits and satisfies design requirements for a complex 3D forging lacking symmetry.

### PRIOR ART DOCUMENT

### Patent Document

(Patent Document 1) Korean Patent Application Publication No. 10-2022-0120415 (laid open on Aug. 30, 2022)

### SUMMARY

Various embodiments are directed to providing a method of designing an optimal preform during a forging process by using 3D U-Net, that is, a type of CNN and a preform design method of removing defects, such as the underfill and folding of a forging according to a preform, through finite element model (FEM) analysis, minimizing a flash and a forging load, and satisfying design requirements for a forging.

A method of designing a preform for manufacturing a three-dimensional (3D) shape according to an embodiment of the present disclosure may include extracting one or more data for simulations from a manufacturing process database including information on a material and forging equipment, generating a plurality of first preforms to which the one or more volume ratios have been applied by using an equipotential surface of Laplace's equation based on a target shape, generating a learning data set by setting parameters of the simulations based on the extracted data and performing a primary finite element model (FEM) analysis simulation on the plurality of first preforms, and training a machine learning (ML) model by using the learning data set.

The extracted data may include one or more of a load limit according to the forging equipment, physical properties of the material, the target shape, a location of the material on a mold, and an equipment speed and temperature condition used in forging.

The generating of the plurality of first preforms to which the one or more volume ratios have been applied by using the equipotential surface of Laplace's equation based on the target shape may include setting a bounding condition for the target shape, analyzing the Laplace's equation by applying the bounding condition to the target shape and a bounding surface, and generating a plurality of first preforms corresponding to an equipotential surface having a specific range based on results of the analysis of the Laplace's equation.

The ML model may be a CNN-based 3D U-Net including an encoding unit configured to extract features from input data by stages and a decoding unit configured to restore a shape based on the extracted features.

The learning data may include one or more of an initial shape during a preforming process, a forged shape that is changed based on process variables during a forging process according to the initial shape, and the target shape.

The generating of the learning data set by setting the parameters of the simulations based on the extracted data and performing the primary finite element model (FEM) analysis simulation on the plurality of first preforms may further include converting shape information into voxel based on results of the primary FEM analysis simulation.

Furthermore, a method of designing a preform for manufacturing a three-dimensional (3D) shape forging according to an embodiment of the present disclosure may include generating a second preform based on features extracted by using a trained machine learning (ML) model, modifying a plurality of second preforms so that a shape of each of the plurality of second preforms has a smooth curve by digitizing the plurality of second preforms, and performing a secondary finite element model (FEM) analysis simulation on the plurality of modified second preforms and determining one final preform based on results of the secondary FEM analysis simulation.

The ML model may be a CNN-based 3D U-Net including an encoding unit configured to extract features from input data by stages and a decoding unit configured to restore a shape based on the extracted features.

The performing of the secondary finite element model (FEM) analysis simulation on the plurality of modified second preforms and determining the one final preform based on the results of the simulation may further include quantitatively evaluating preforming design efficiency of an output according to the FEM analysis simulation based on a forging volume efficiency index (FVEI). The FVEI may satisfy an equation below.

$$FVEI = ( \frac{{V}_{preform}}{{V}_{target}} + \frac{{V}_{target}}{{V}_{preform}} - 2 ) + ( \frac{{V}_{flash}}{{V}_{target}} ) + {w}_{a} \cdot ( \frac{{V}_{underfill}}{{V}_{target}} ) + {w}_{b} \cdot ( \frac{{V}_{folding}}{{V}_{target}} )$$

The method may further include including the output of the secondary FEM analysis simulation in a learning data set when preforming design efficiency of the output of the secondary FEM analysis simulation is a predetermined level or less, after quantitatively evaluating the preforming design efficiency based on an FVEI.

Furthermore, a system for designing a preform for manufacturing a 3D shape forging according to an embodiment of the present disclosure may include a manufacturing process database including information on a material and forging equipment, a preform generator configured to extract one or more data for simulations and to generate a plurality of first preforms to which the one or more volume ratios have been applied by using an equipotential surface of Laplace's equation based on a target shape, a learning data generator configured to generate a learning data set by setting parameters of the simulations based on the extracted data and performing a primary finite element model (FEM) analysis simulation on the plurality of first preforms, a machine learning (ML) model trained by using the learning data set and configured to derive a plurality of modified second preforms for a target shape, a smoothing unit configured to modify the plurality of second preforms so that a shape of each of the plurality of second preforms has a smooth curve by digitizing the plurality of second preforms, and a preform selector configured to determine one final preform by performing a secondary FEM analysis simulation on the plurality of modified second preforms.

According to embodiments of the present disclosure, it is possible to remove the underfill and folding defects of a forging, to minimize a flash and a load, and to design a preform that satisfies design requirements, such as the degree of crystal grain of a target and a flow line, through the same method as a method of removing a folding defect by providing the method of designing a 3D preform during a forging process by applying a CNN algorithm using FEM analysis.

### BRIEF DESCRIPTION OF THE DRAWINGS

FIG. 1 is a diagram illustrating a method of designing a digital preform using a convolutional neural network (CNN) according to design conditions for a three-dimensional (3D) shape forging according to an embodiment of the present disclosure.

FIG. 2 is a schematic diagram of a concept that an initial preform is generated in the method of designing a digital preform using a CNN according to design conditions for a 3D shape forging according to an embodiment of the present disclosure.

FIG. 3 is a diagram exemplifying the results of the execution of finite element model (FEM) analysis and the results of voxel conversion in the method of designing a digital preform using a CNN according to design conditions for a 3D shape forging according to an embodiment of the present disclosure.

FIG. 4 is a diagram illustrating the structure of a part of a network of a machine learning (ML) model to which the method of designing a digital preform using a CNN according to design conditions for a 3D shape forging according to an embodiment of the present disclosure has been applied.

FIG. 5 is an exemplary diagram of a smoothing process that is applied to the method of designing a digital preform using a CNN according to design conditions for a 3D shape forging according to an embodiment of the present disclosure.

FIG. 6 is an exemplary diagram of forging results to which a basic shape in which a preform is not considered has been applied during a forging design process.

FIG. 7 is an exemplary diagram of a preform designed by removing various defects during a forging design process and results obtained by forging the preform.

FIG. 8 is an exemplary diagram of the results of forging in the cases in which a load limit is considered and a load limit is not considered when learning data are generated during a forging design process.

FIG. 9 is a schematic diagram of the results of the calculation of an FVEI that is applied to the method of designing a digital preform using a CNN according to design conditions for a 3D shape forging according to an embodiment of the present disclosure.

FIG. 10 is a diagram illustrating the structure of a system for designing a digital preform using a CNN according to design conditions for a 3D shape forging according to an embodiment of the present disclosure.

### DETAILED DESCRIPTION

Hereinafter, the present disclosure is described in detail with reference to the accompanying drawings and embodiments.

It is to be noted that technological terms used in the present disclosure are used to describe only specific embodiments and are not intended to limit the present disclosure. Furthermore, the technological terms used in the present disclosure should be construed as having meanings that are commonly understood by those skilled in the art to which the present disclosure pertains unless especially defined as different meanings otherwise in the present disclosure, and should not be construed as having excessively comprehensive meanings or excessively reduced meanings. Furthermore, if the technological terms used in the present disclosure are wrong technological terms that do not precisely represent the spirit of the present disclosure, they should be replaced with technological terms that may be correctly understood by those skilled in the art and understood. Furthermore, common terms used in the present disclosure should be interpreted in accordance with the definition of dictionaries or in accordance with the context, and should not be construed as having excessively reduced meanings.

Furthermore, an expression of the singular number used in this specification includes an expression of the plural number unless clearly defined otherwise in the context. In this application, terms, such as “include” and “comprise”, should not be construed as essentially including all various components or various steps described in the specification, but the terms may be construed as not including some of the components or steps or as including additional components or steps.

Furthermore, terms including ordinal numbers, such as a “first” and a “second”, which are used in the present disclosure, may be used to describe various components, but the components are not restricted by the terms. The terms are used to only distinguish one component from the other components. For example, a first component may be named a second component without departing from the scope of rights of the present disclosure. Likewise, the second component may be named the first component.

Hereinafter, embodiments according to the present disclosure are described in detail with reference to the accompanying drawings. The same or similar component is assigned the same reference numeral regardless of its reference numeral, and a redundant description thereof is omitted.

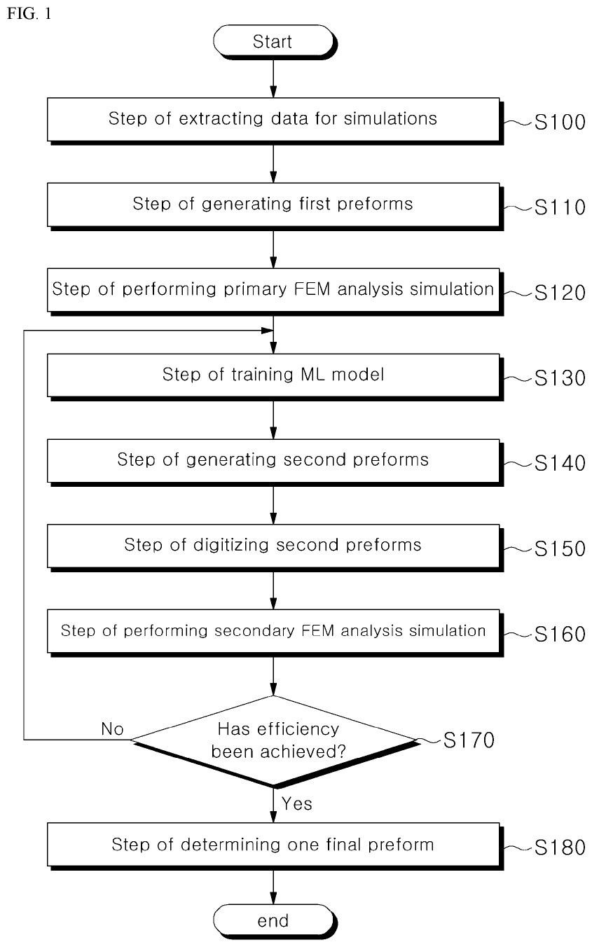

FIG. 1 is a diagram illustrating a method of designing a digital preform using a convolutional neural network (CNN) according to design conditions for a three-dimensional (3D) shape forging according to an embodiment of the present disclosure.

Referring to FIG. 1, the method of designing a digital preform using a CNN according to design conditions for a 3D shape forging according to an embodiment of the present disclosure is a method of designing a preform for manufacturing a 3D shape forging, and may include step S100 of extracting one or more data for simulations from a manufacturing process database including information on a material and forging equipment, step S110 of generating a plurality of first preforms to which one or more volume ratios have been applied by using an equipotential surface of Laplace's equation based on a target shape, step S120 of generating a learning data set by setting parameters of the simulations based on the extracted data and performing a primary FEM analysis simulation on the plurality of first preforms, step S130 of training a machine learning (ML) model by using the learning data set, step S140 of generating a plurality of second preforms based on features extracted by using the trained ML model, step S150 of modifying the plurality of second preforms so that a shape of each of the plurality of second preforms has a smooth curve by digitizing the plurality of second preforms, and steps S160 to S180 of performing a secondary FEM analysis simulation on the plurality of modified second preforms and determining one final preform based on the results of the simulations.

Specifically, in step S100 of extracting one or more data for simulations from a manufacturing process database including information on a material and forging equipment, the method of designing a preform according to an embodiment of the present disclosure is performed based on a manufacturing process database including information, such as the limit of a forging load, the characteristics of a material, and a target shape. The one or more data may be used as an input value for a finite element model (FEM) analysis simulation.

Accordingly, a system for designing a digital preform using a CNN according to design conditions for a 3D shape forging may extract one or more data related to forging equipment, including a material, such as the limit of a forging load and a target shape, with reference to the manufacturing process database.

Thereafter, shape information generated through simulations is converted into a voxel grid and standardized, and is used to train a machine learning (ML) model.

Next, step S110 of generating a plurality of first preforms to which one or more volume ratios have been applied by using an equipotential surface of Laplace's equation based on a target shape is a process of preparing an initial learning data set for training the ML model, and may include setting the equipotential surface in a region defined by forged shape and bounding surfaces and generating a plurality of preforms to which various volume ratios have been applied in preparation for the target shape.

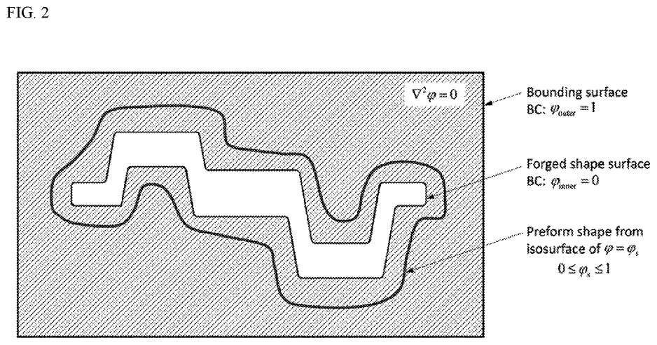

FIG. 2 is a schematic diagram of a concept that an initial preform is generated in the method of designing a digital preform using a CNN according to design conditions for a 3D shape forging according to an embodiment of the present disclosure. Referring to FIG. 2, Laplace's equation for generating the initial preform may be expressed as in the following equation.

$${∇}^{2} Φ = O \qquad ( 1 )$$

In Equation 1, Φ is a scalar function. The domain of the equation is a gray region restricted by forged shape and bounding surfaces. In this case, the bounding surface may be arbitrarily set, but the forged shape surface must be included. The bounding surface and the forged shape surface have bounding conditions “Φₒᵤₜₑᵣ=1 and Φᵢₙₙₑᵣ=0”, respectively.

Furthermore, after the Laplace's equation is solved, the equipotential surface that is Φ=Φₛ may be set as a preform for the forged shape in the range of 0≤Φₛ≤1. If a forged shape when Φₛ=0 is defined as the target shape and the bounding surface has the same shape as a circular blank during a forging process, a preform generated in an equipotential surface of Φₛ=1 has the same shape as the circular blank.

Furthermore, the initial learning data set may be generated by using an equipotential surface of Φₛ=0.10, 0.12, . . . , 0.40. The scale of the volume of each preform may be adjusted so that the volume of each preform is identical with the volume of the target shape because the volume of the equipotential surface is greater than the volume of the target shape. Furthermore, an additional molding body is generated so that each preform has a greater volume than the target shape by 0%, 5%, 10%, . . . , 30% by considering the influence of a flash and a molding failure.

Next, step S120 of generating a learning data set by setting parameters of the simulations based on the extracted data and performing a primary FEM analysis simulation on the plurality of first preforms is a step of constructing the learning data set by using the plurality of first preforms generated in step S110. To this end, the primary FEM analysis simulation is performed.

To this end, the system may define information, such as the limit of a forging load, the characteristics of a material including the physical properties of the material, a target shape, the location of the material on a mold, and an equipment speed and temperature condition used in forging, which are extracted in step S100, by inputting the information to a FEM analysis tool, and may perform FEM analysis on the plurality of first preforms.

Furthermore, step S120 may further include a step of converting shape information according to the results of the primary FEM analysis simulation into voxel.

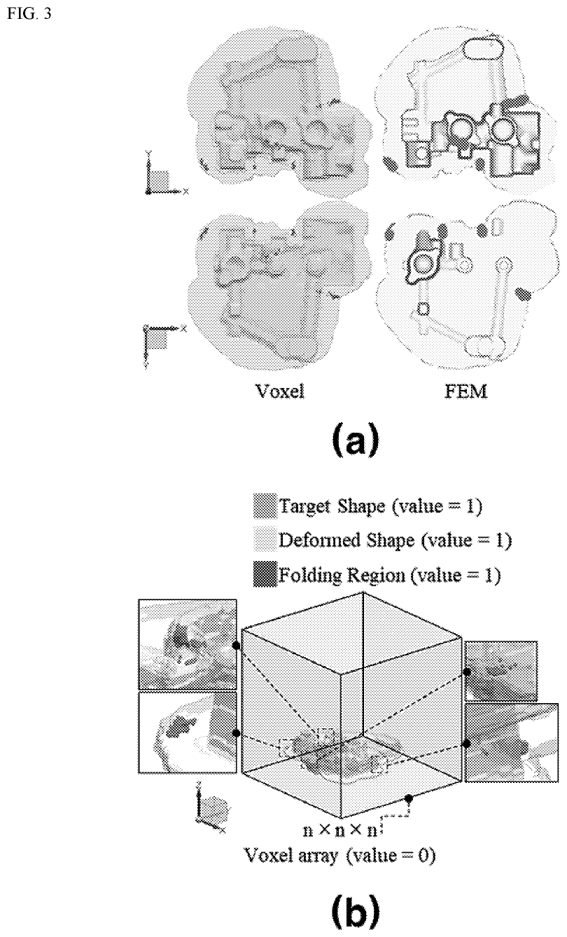

FIG. 3 is a diagram exemplifying the results of the execution of FEM analysis and the results of voxel conversion in the method of designing a digital preform using a CNN according to design conditions for a 3D shape forging according to an embodiment of the present disclosure.

FIG. 3 illustrates that shape information has been converted into voxel through nodes and elements of FEM analysis and information on a location where a folding defect occurs. From FIG. 3(a), it may be seen that the results of the conversion quite correspond to the results of the FEM analysis composed of a mesh (a). Relative coordinates according to a shape can be applied because coordinates are included in the node.

Upon voxel conversion, a cube space (n×n×n) having a voxel value of 0 is generated on the basis of an axis having the greatest difference between maximum and minimum coordinates in the x, y, and z axes of shape information of all of the learning data sets (the shape information includes an initial shape prior to deformation, a shape forged based on the initial shape, and a target shape). Shape information having a voxel value of 1 is disposed within the space (FIG. 3(b)). This is for reflecting the influence of an initial shape and an initial location on a forged shape in training.

Furthermore, the location of a folding defect region is reflected in modified shape information. The value of the location where the folding defect occurs and the value of the location where a folding defect does not occur are classified into “f=1” and “f=0”, respectively, according to binary categories. Accordingly, initial voxel data having various sizes unified into “n×n×n” is resized as a size of 128×128×128, thereby maintaining the consistency of model training and enabling memory to be efficiently used. A linear interpolation method is applied to an interpolation process so that the characteristics of original data can be preserved as much as possible.

Additionally, design targets, such as a crystal grain and a flow line, may also be converted into voxel data identically with the folding defect and used for training. This may be said to be a method for achieving design requirements.

Next, in step S130 of training an ML model by using the learning data set, the ML model mounted on the system is trained by using a voxel type of the preforms derived according to the primary FEM analysis.

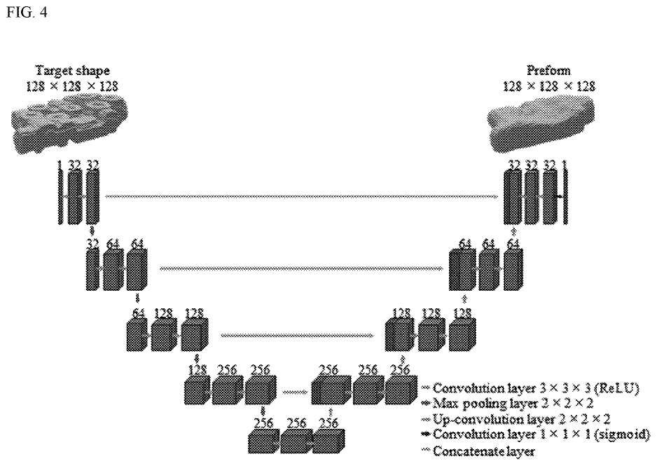

FIG. 4 is a diagram illustrating the structure of a part of a network of a ML model to which the method of designing a digital preform using a CNN according to design conditions for a 3D shape forging according to an embodiment of the present disclosure has been applied.

Referring to FIG. 4 together, according to embodiments of the present disclosure, a preform is designed by using a CNN-based 3D U-Net structure. A network illustrated in FIG. 4 may process input voxel data (i.e., simulation results of the first preform) by using a 3D convolutional layer. One or more features may be extracted from the processed input voxel data so that an optimal preform is designed based on the one or more features. The structure of the network may include an encoder part that extracts features from input data by stages and a decoder part that restores a shape based on extracted information.

Specifically, a CNN model may operate in a way to generate an optimal preform shape by processing input voxel data. The CNN model may receive voxel data of a target shape in an initial step and gradually extract high-dimensional features of the voxel data by using the 3D convolutional layer.

During this process, the network generates a feature map and gradually reduces the size of the data while maintaining important spatial features. In particular, the encoder part of the model may remove unnecessary information with only major features left by applying a pooling operation, and may extract elements essential to determine a preform shape.

Thereafter, in the decoder step, a process of restoring the preform shape to an original shape is performed based on information compressed by the encoder part. During this process, resolution of the feature map is restored by applying an up-sampling scheme. Finally, a preform shape suitable for the target shape may be generated. During the up-sampling process, a preform is designed to enable more precise restoration while maintaining important spatial information extracted in the encoder step by using a skip connection.

In the last step of the network, an optimized preform shape is output based on learning information. During this process, the ML model has been designed to learn a deformation pattern of a shape during a forging process and then generate a preform suitable for the target shape. It is considered that an optimized preform can be deformed into the target shape during the forging process.

That is, according to embodiments of the present disclosure, the quantitative and automated design of a preform is made possible compared to the existing empirical methods by applying the CNN model. The existing design method has a strong tendency to rely on experiences and trial and error. If the CNN model according to embodiments of the present disclosure is used, however, generalization performance for various shapes and an initial location difference can be improved.

Furthermore, it is possible to minimize the waste of materials and improve shape accuracy during the forging process because the CNN model is trained to generate an optimal preform based on a target shape during the CNN model training process.

When the CNN model of the ML model is trained, the learning data set may be divided into an initial shape in a preform step, a forged shape according to the initial shape, and a target shape. All of the initial shape, the forged shape, and the target shape may be converted into voxel data and input to the CNN model.

Next, step S140 of generating a plurality of second preforms based on features extracted by using the trained machine learning model is a step of deriving a plurality of second preforms by using the ML model trained by using the plurality of first preforms as the learning data set.

In particular, according to embodiments of the present disclosure, an initial shape refers to a preform. A forged shape refers to a shape that is changed due to various forging process variables, such as an initial shape, a location on a mold, and load conditions. Furthermore, a target shape refers to a final shape in which design requirements are reflected. A machine learning (ML) model according to an embodiment of the present disclosure is trained to predict and design a preform, that is, an initial shape that may be used to forge a final shape in which design requirements are reflected, by learning the initial shape and a forged shape modified according to the initial shape.

Next, in step S150 of modifying the plurality of second preforms so that a shape of each of the plurality of second preforms has a smooth curve by digitizing the plurality of second preforms, smoothing processing may be performed on the plurality of second preforms generated through the ML model.

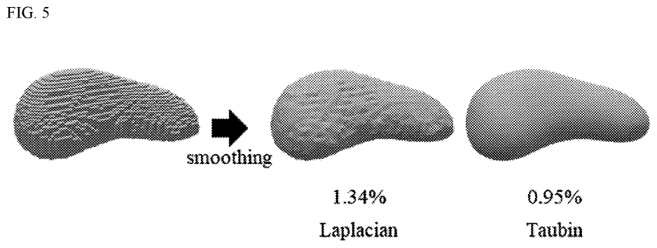

FIG. 5 is an exemplary diagram of a smoothing process that is applied to the method of designing a digital preform using a CNN according to design conditions for a 3D shape forging according to an embodiment of the present disclosure.

Referring to FIG. 5 together, in an embodiment of the present disclosure, voxel is a 1 mm³ volume element and indicates the value of a regular grid unit in a 3D space. The voxel is generated to have a shape, such as a step, when a curved surface is generated, due to special properties of a grid format.

In order to supplement such a shape, as illustrated in FIG. 5, a step shape of a preform may be smoothly converted.

Furthermore, in step S160 of performing a secondary FEM analysis simulation on the plurality of modified second preforms and determining one final preform based on the results of the simulations, an optimal final preform is derived through simulations for the plurality of modified second preforms.

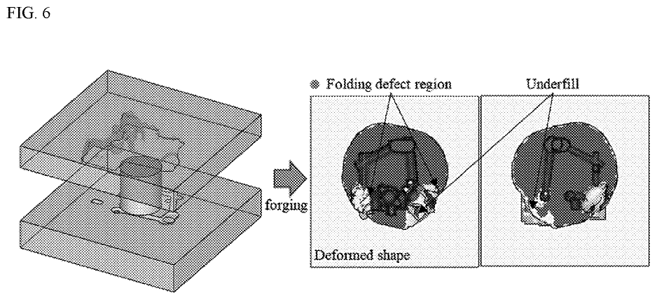

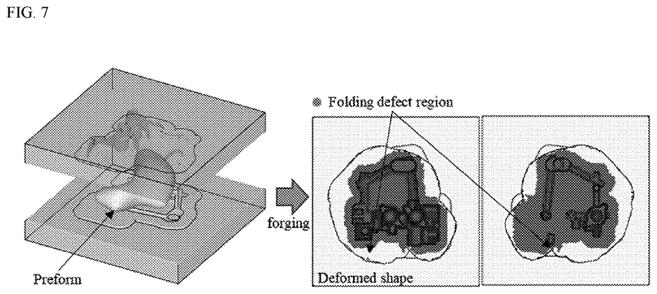

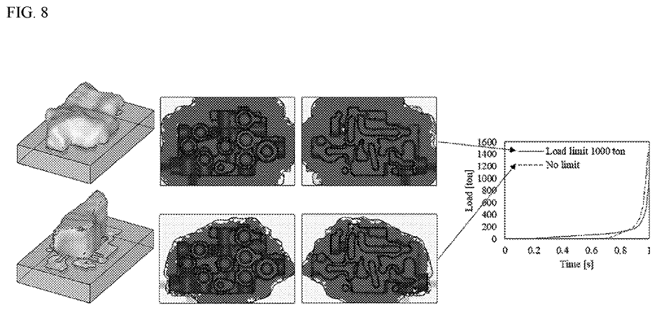

FIG. 6 is an exemplary diagram of forging results to which a basic shape in which a preform is not considered has been applied during a forging design process. FIG. 7 is an exemplary diagram of a preform designed by removing various defects during a forging design process and results obtained by forging the preform. FIG. 8 is an exemplary diagram of the results of forging in the cases in which a load limit is considered and a load limit is not considered when learning data are generated during a forging design process.

Referring to FIGS. 6 to 8 together, FIG. 6 illustrates forging results to which a basic shape having a preform not considered has been applied. During such a forging process, a joint is formed because metal is not properly spread within a mold and a part of the metal is folded. This is a folding defect, which degrades the mechanical properties of a product and may be considered as a fatal defect that hinders a target shape from being manufactured.

Furthermore, FIG. 7 illustrates a preform designed by removing folding and underfill defects and considering the minimizing of a flash and a load and the result of the forging of the preform. In a modified shape, a gray region illustrates a contact area of a mold and a material, and an orange region indicates a folding defect location.

In this case, the folding defect enables design requirements to be achieved by replacing a folding defect with the degree of a crystal grain and a flow line in voxel data.

Furthermore, a load according to forging equipment has been determined. A preform is used for forging within the load limit of forging equipment. FIG. 8 illustrates preforms when a load limit is reflected and when the load limit is not reflected during a process of generating a learning data set and results obtained by forging the preforms. FIG. 8 illustrates that molding is possible less than a load limit of 1000 ton when the load limit is reflected.

By considering such contents, in step S160, secondary FEM analysis may be performed on the plurality of second preforms derived by the ML model. Efficiency of the results of simulations results is determined (S170).

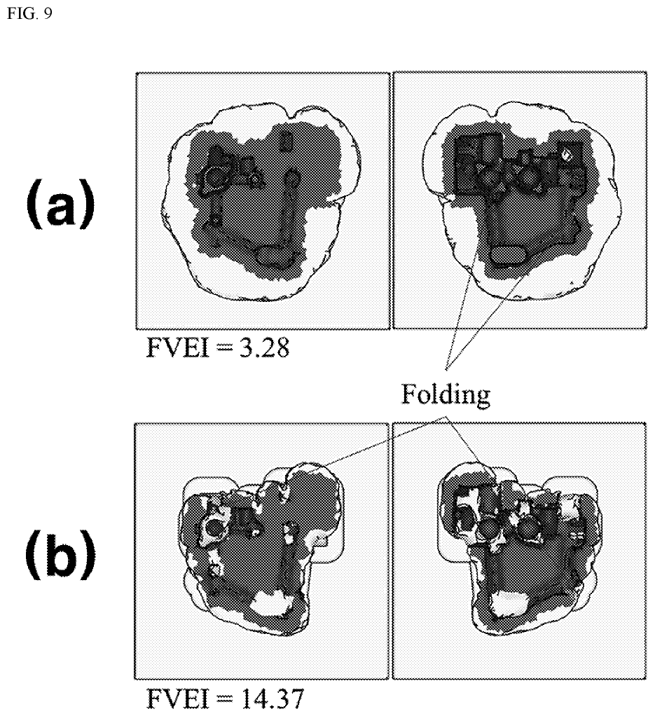

FIG. 9 is a schematic diagram of the results of the calculation of a forging volume efficiency index (FVEI) that is applied to the method of designing a digital preform using a CNN according to design conditions for a 3D shape forging according to an embodiment of the present disclosure.

A shape converted into the voxel is a set of 1 mm³ volume elements, and the location and volume of the shape may be calculated. The volume of underfill, the volume of a flash, and the volume of a folding defect in the shape may be calculated digitized suitably for a design target. Accordingly, a forging according to a preform can be quantitatively evaluated, and a preform can be selected. This is called a forging volume efficiency index (FVEI).

Referring to FIG. 9, an FVEI for quantitatively evaluating preforming design efficiency during a forging process indicates a comprehensive index in which a volume ratio of a preform and a target shape is reflected and the occurrence of defects, such as the forming of a flash, underfill, and folding, is considered. This may be defined by Equation 2.

$$FVEI = ( \frac{{V}_{preform}}{{V}_{target}} + \frac{{V}_{target}}{{V}_{preform}} - 2 ) + ( \frac{{V}_{flash}}{{V}_{target}} ) + {w}_{a} \cdot ( \frac{{V}_{underfill}}{{V}_{target}} ) + {w}_{b} \cdot ( \frac{{V}_{folding}}{{V}_{target}} ) \qquad ( 2 )$$

In Equation 2, V_{preform} may indicate the volume of a preform. V_{target} may indicate the volume of a target shape. V_{flash} may indicate the volume of a flash. V_{underfill} may indicate the volume of underfill. V_{folding} may indicate the volume of a folding defect.

The FVEI includes four major items. Each of the four major items may reflect an important element in the design of a preform. The first term assigns a penalty when a relative difference between the volumes of a preform and a target shape falls outside an optimal volume by measuring the relative difference. When the volume of a preform is greater than a target shape, there is a good possibility that an unnecessary material may be used and a flash may be formed. When the volume of a preform is not sufficient, a danger of underfill is increased. For example, when the volume of a preform is 1.2 times the volume of a target shape, the value of a penalty is 2.03. When the volume of a preform is 0.8 times the volume of a target shape, the value of a penalty is 2.05. This means that the design of a preform is guided to prevent the use of an unnecessary material and the occurrence of a defect because the penalty is increased as the difference between the volumes of the preform and the target shape is increased.

The second term is reflected as an element that wastes a material and degrades process efficiency by evaluating a relative volume ratio of a flash. The flash is an element that inevitably occurs during a forging process, but it is important to reduce a flash because an excessive flash results in unnecessary post-processing costs.

The third term is an element that evaluates the occurrence of underfill and has a direct influence on geometric accuracy and mechanical properties of a product. The underfill refers to a phenomenon in which a material does not sufficiently fill a cavity of a mold during a forging process and may be considered as a product defect. Accordingly, in order to highlight the influence of underfill, the underfill is set to have higher importance in design evaluation by assigning a weight wₐ.

The fourth term is an element that evaluates a folding defect and is an important factor that causes an internal structural defect of a product. The folding occurs because a flow of a material abnormally merges, and may degrade performance of a product by reducing fatigue strength. Accordingly, in order to properly reflect a folding defect, the folding defect is guided to be minimized during a design process by applying a weight w_{b}.

The FVEI may be used as an index capable of quantitatively analyzing preforming design efficiency during a forging process by breaking away from a simple empirical design method. The existing design evaluation method chiefly relies on experiences and intuition of a designer. However, systematic design evaluation in which all of the minimization of a flash, the prevention of underfill, and the removal of a folding defect may be considered by introducing the FVEI is made possible.

Accordingly, the present disclosure can improve the productivity of a forging process and contribute to deriving an optimized final preform shape.

Furthermore, when a corresponding second preform does not reach a predetermined FVEI reference or more based on the results of the calculation of the FVEI, corresponding data is used as learning data (S120). When the second preform reaches the predetermined FVEI reference or more, the corresponding second preform is determined as a final preform (S180).

Hereinafter, the structure of a system in which the method of designing a digital preform using a CNN according to design conditions for a 3D shape forging according to an embodiment of the present disclosure has been implemented is described in detail.

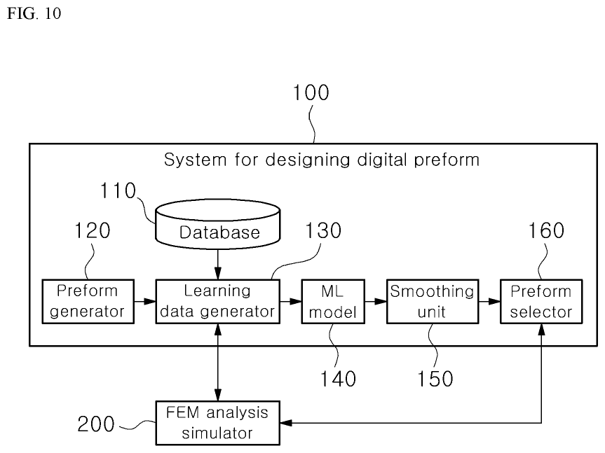

FIG. 10 is a diagram illustrating the structure of a system for designing a digital preform using a CNN according to design conditions for a 3D shape forging according to an embodiment of the present disclosure

In the following description, each component of the system may be implemented in the form of a program executable by a microprocessor and may be written in a readable and writable recording medium.

Referring to FIG. 10, a system 100 for designing a digital preform using a CNN according to design conditions for a 3D shape forging according to an embodiment of the present disclosure is a system for designing a preform for manufacturing a 3D shape forging. The system may include a manufacturing process database 110 including information on a material and forging equipment, a preform generator 120 configured to extract one or more data for simulations and to generate a plurality of first preforms to which one or more volume ratios have been applied by using an equipotential surface of Laplace's equation based on a target shape, a learning data generator 130 configured to generate a learning data set by setting parameters of the simulations based on the extracted data and performing a primary FEM analysis simulation on the plurality of first preforms, an ML model 140 trained by using the learning data set and configured to derive a plurality of modified second preforms for the target shape, a smoothing unit 150 configured to modify the plurality of second preforms so that a shape of each of the plurality of second preforms has a smooth curve by digitizing the plurality of second preforms, and a preform selector 160 configured to determine one final preform by performing a secondary FEM analysis simulation on the plurality of modified second preforms.

The database 110 is a database in which data related to a manufacturing process is stored, and may store information, such as the limit of a forging load, the characteristics of a material, and a target shape.

The preform generator 120 may generate a plurality of first preforms to which one or more volume ratios have been applied by using an equipotential surface of Laplace's equation based on a target shape.

The learning data generator 130 may prepare a learning data set by extracting the information, such as the limit of a forging load from the database 110, defining parameters by inputting the information to an FEM analysis simulator 200, performing FEM analysis simulations on the first preform, and converting shape information that is the results of the execution of the FEM analysis simulations into voxel data.

The ML model 140 may be a CNN-based ML model and may perform learning based on the prepared learning data set. The learning data set may include a voxel data type of an initial shape, forging results, and a target shape.

Furthermore, the trained ML model 140 may generate second preforms in which design requirements have been reflected from the plurality of first preforms based on an extracted feature map.

The smoothing unit 150 may perform digitizing on the second preforms. The digitizing may include a process of performing smoothing processing on a grid unit included in the voxel data having a grid format.

The preform selector 160 may perform a secondary FEM analysis simulation on the smoothed second preforms through the FEM analysis simulator 200 and derive an optimal final preform based on the results of the execution of the secondary FEM analysis simulation. In this case, when a corresponding second preform does not currently satisfy efficiency having an FVEI reference value or more based on the results of the simulation, corresponding data may be used as a learning data set and used in the training of the ML model 140. When the corresponding second preform satisfies the efficiency, the corresponding second preform may be selected as a final preform.

Although many contents have been described in detail in the description, such contents should be interpreted as an example of a preferred embodiment rather than limiting the scope of the disclosure. Accordingly, the present disclosure should not be determined by the aforementioned embodiments, but should be determined by the claims and equivalents of the claims.

[Description of reference numerals]

| | |
|---|---|
| 110: database | 120: preform generator |
| 130: learning data generator | |
| 140: ML model | 150: smoothing unit |
| 160: preform selector | |

What is claimed is:

1. A method of designing a digital preform using a convolutional neural network (CNN) according to design conditions for a three-dimensional (3D) shape forging as a method of designing a preform for manufacturing a 3D shape forging, the method comprising:
extracting one or more data for simulations from a manufacturing process database including information on a material and forging equipment;
generating a plurality of first preforms to which the one or more volume ratios have been applied by using an equipotential surface of Laplace's equation based on a target shape;
generating a learning data set by setting parameters of the simulations based on the extracted data and performing a primary finite element model (FEM) analysis simulation on the plurality of first preforms; and
training a machine learning (ML) model by using the learning data set.

2. The method of claim 1, wherein the extracted data comprises one or more of a load limit according to the forging equipment, physical properties of the material, the target shape, a location of the material on a mold, and an equipment speed and temperature condition used in forging.

3. The method of claim 2, wherein the generating of the plurality of first preforms to which the one or more volume ratios have been applied by using the equipotential surface of Laplace's equation based on the target shape comprises:
setting a bounding condition for the target shape;
analyzing the Laplace's equation by applying the bounding condition to the target shape and a bounding surface; and
generating a plurality of first preforms corresponding to an equipotential surface having a specific range based on results of the analysis of the Laplace's equation.

4. The method of claim 1, wherein the ML model is a CNN-based 3D U-Net comprising an encoding unit configured to extract features from input data by stages and a decoding unit configured to restore a shape based on the extracted features.

5. The method of claim 4, wherein the learning data comprises one or more of an initial shape during a preforming process, a forged shape that is changed based on process variables during a forging process according to the initial shape, and the target shape.

6. The method of claim 1, wherein the generating of the learning data set by setting the parameters of the simulations based on the extracted data and performing the primary finite element model (FEM) analysis simulation on the plurality of first preforms further comprises converting shape information into voxel based on results of the primary FEM analysis simulation.

7. A method of designing a digital preform using a convolutional neural network (CNN) according to design conditions for a three-dimensional (3D) shape forging as a method of designing a preform for manufacturing a 3D shape forging, the method comprising:
generating a second preform based on features extracted by using a trained machine learning (ML) model;
modifying a plurality of second preforms so that a shape of each of the plurality of second preforms has a smooth curve by digitizing the plurality of second preforms; and
performing a secondary finite element model (FEM) analysis simulation on the plurality of modified second preforms and determining one final preform based on results of the secondary FEM analysis simulation.

8. The method of claim 7, wherein the ML model is a CNN-based 3D U-Net comprising an encoding unit configured to extract features from input data by stages and a decoding unit configured to restore a shape based on the extracted features.

9. The method of claim 7, wherein:
the performing of the secondary finite element model (FEM) analysis simulation on the plurality of modified second preforms and determining the one final preform based on the results of the simulation further comprises quantitatively evaluating preforming design efficiency of an output according to the FEM analysis simulation based on a forging volume efficiency index (FVEI), and
the FVEI satisfies an equation below
$$FVEI = ( \frac{{V}_{preform}}{{V}_{target}} + \frac{{V}_{target}}{{V}_{preform}} - 2 ) + ( \frac{{V}_{flash}}{{V}_{target}} ) + {w}_{a} \cdot ( \frac{{V}_{underfill}}{{V}_{target}} ) + {w}_{b} \cdot ( \frac{{V}_{folding}}{{V}_{target}} )$$
(wherein V_{preform} is a volume of a preform, V_{target} is a volume of a target shape, V_{flash} is a volume of a flash, V_{underfill} is a volume of underfill, and V_{folding} is a volume of a folding defect).

10. The method of claim 7, further comprising including an output of the secondary FEM analysis simulation in a learning data set when preforming design efficiency of the output of the secondary FEM analysis simulation is a predetermined level or less, after quantitatively evaluating the preforming design efficiency based on an FVEI.

11. A system for designing a digital preform using a convolutional neural network (CNN) according to design conditions for a three-dimensional (3D) shape forging as a system for designing a preform for manufacturing a 3D shape forging, the system comprising:
a manufacturing process database including information on a material and forging equipment;
a preform generator configured to extract one or more data for simulations and to generate a plurality of first preforms to which the one or more volume ratios have been applied by using an equipotential surface of Laplace's equation based on a target shape;
a learning data generator configured to generate a learning data set by setting parameters of the simulations based on the extracted data and performing a primary finite element model (FEM) analysis simulation on the plurality of first preforms;
a machine learning (ML) model trained by using the learning data set and configured to derive a plurality of modified second preforms for a target shape;
a smoothing unit configured to modify the plurality of second preforms so that a shape of each of the plurality of second preforms has a smooth curve by digitizing the plurality of second preforms; and
a preform selector configured to determine one final preform by performing a secondary FEM analysis simulation on the plurality of modified second preforms.
